(19) United States
(12) Patent Application Publication
(10) Pub. No.: US 2025/0258026 A1
(43) Pub. Date: Aug. 14, 2025

(54) FORWARD AND REVERSE BIDIRECTIONAL FLOW RATE MEASUREMENT METHOD FOR SUBSEA CHEMICAL AGENT INJECTION DEVICE

(71) Applicants: CNOOC (CHINA) CO., LTD, Tianjin (CN); CNOOC CHINA LIMITED, HAINAN BRANCH, Haikou (CN); HAIMO SUBSEA TECHNOLOGY (SHANGHAI) CO., LTD., Shanghai (CN)

(72) Inventors: Haodong CHEN, Haikou (CN); Xiaowei MA, Shanghai (CN); Chunmin ZENG, Haikou (CN); Guangfu LI, Shanghai (CN); Anchao WEI, Haikou (CN); Yanzhi PAN, Shanghai (CN); Ming LUO, Haikou (CN); Tan XIAO, Haikou (CN); Donglei JIANG, Haikou (CN); Huan DIAO, Haikou (CN)

(73) Assignees: CNOOC (CHINA) CO., LTD, Tianjin (CN); CNOOC CHINA LIMITED, HAINAN BRANCH, Haikou (CN); HAIMO SUBSEA TECHNOLOGY (SHANGHAI) CO., LTD., Shanghai (CN)

(21) Appl. No.: 19/112,278

(22) PCT Filed: Aug. 27, 2024
(86) PCT No.: PCT/CN2024/114663

§ 371 Date: Mar. 17, 2025

(30) Foreign Application Priority Data
Sep. 28, 2023 (CN) 202311271924.0

(51) Int. Cl. G01F 1/36; F17D 3/12; F17D 3/18

(52) U.S. Cl. CPC G01F 1/363; F17D 3/18; F17D 3/12

(57) ABSTRACT

A forward and reverse bidirectional flow rate measurement method for a subsea chemical agent injection device is provided. The device includes a device body, a flow channel is formed inside the device body, the device body includes an agent input connector, a pressure reduction member, a needle valve assembly, and an agent output connector that are sequentially communicated through the flow channel; and the method is implemented by: calibrating forward and reverse flow of agents at different openings and flow rates, then obtaining differential pressures before and after the agents flow through the needle value assembly; fitting relationships between the flow rates and the differential pressures at different openings to obtain a plurality of arrays of opening-flow coefficients; then fitting relationships between the flow coefficients and the needle valve openings to establish a formula for the flow rate and the opening-differential pressure, and finally performing the measurement in real time.

### CROSS REFERENCE TO THE RELATED APPLICATIONS

This application is the national phase entry of International Application No. PCT/CN2024/114663, filed on Aug. 27, 2024, which is based upon and claims priority to Chinese Patent Application No. 202311271924.0, filed on Sep. 28, 2023, the entire contents of which are incorporated herein by reference.

### TECHNICAL FIELD

The present disclosure relates to the field of petroleum engineering, and particularly relates to a chemical agent injection control method for a subsea Christmas tree network.

### BACKGROUND

In order to ensure the normal operation of a subsea oil pipeline, and improve the service life and production efficiency of the subsea oil pipeline, it is necessary to inject various agents into the pipeline through a subsea injection device at regular intervals. Regarding the subsea injection device, the Chinese Patent Application (Application No.: CN202110934610.9) previously submitted by the applicant provides a structure of a subsea agent injection device, which indicates that an orifice plate and a flow channel groove can reduce a pressure of the high-pressure agent flowing through the device. However, the following problems were discovered in subsequent practice:

(1) since an original pipeline of a subsea Christmas tree is not correctly installed, an inlet of the subsea agent injection device is connected to a corresponding outlet of the Christmas tree, and an outlet of the subsea agent injection device is connected to a corresponding inlet of the Christmas tree; since relevant parameters of the subsea agent injection device are calibrated in advance based on a default state that the agent would flow in a forward direction inside the subsea agent injection device, an incorrect installation of the original pipeline will cause the agent to flow in a reverse direction inside the device, which further results in mismatch of parameters, preventing accurate measurement of the agent flow rate, in which case, it is necessary to pause the injection of the agent into the subsea agent injection device, to reinstall the device in a correct direction, resulting in an increase in the installation costs, and affecting the operation and maintenance of a pipeline network. In order to prevent similar situations from occurring in the future, it is necessary to calibrate relevant parameters of the forward and reverse flows of the agent that is injected into the subsea agent injection device, such that the forward and reverse flows of the agent can be accurately measured.

(2) For the purpose of controlling flow stability, designers introduced a needle valve to control a flow rate of the agent. However, when a needle value opening is different, relevant flow rate parameters will also change, therefore, it is impossible to measure the flow rate with fixed parameters. Thus, it is necessary to establish a relationship between flow rate and valve opening, so as to accurately measure the flow rate in real time.

### SUMMARY

In order to solve the above technical problems, the present disclosure mainly adopts the following technical solution:

A forward and reverse bidirectional flow rate measurement method for a subsea chemical agent injection device, including a device body, where a flow channel is formed inside the device body, the device body includes an agent input connector, a pressure reduction member, a needle valve assembly, and an agent output connector that are sequentially communicated through the flow channel:
step 1: keeping an opening V of the needle valve assembly fixed, taking the agent input connector and the agent output connector as inlets to inject agents with different calibrated flow rates Q into the device body for forward and reverse bidirectional calibration, and synchronously obtaining first differential pressures DP1 before and after the chemical agent flows through the pressure reduction member, and second differential pressures DP2 before and after the chemical agent flows through the needle valve assembly during a period; and
obtaining a forward calibration array and a reverse calibration array for the opening V;
step 2. fitting relationships between flow rates and differential pressures in forward and reverse directions at the same opening V according to Formula \textcircled{1}:

$$\{ \begin{matrix}{Q}_{A} = {K}_{A} * \sqrt{{DPn}_{A}} + {C}_{A} \\ {Q}_{B} = {K}_{B} * \sqrt{{DPn}_{B}} + {C}_{B}\end{matrix} , \qquad Formula 1$$

in the formula:
Q_{A} is a forward flow rate; K_{A} is a forward flow coefficient; C_{A} is a forward calibration coefficient; DPn_{A} is either DP1_{A} or DP2_{A}, DP1_{A} is a forward first differential pressure, and DP2_{A} is a forward second differential pressure; and
Q_{B} is a reverse flow rate; K_{B} is a reverse flow coefficient; C_{B} is a reverse calibration coefficient; DPn_{B} is either DP1_{B} or DP2_{B}, DP1_{B} is a reverse first differential pressure, and DP2_{B} is a reverse second differential pressure;
step 3. adjusting the needle valve assembly (5) to different openings V, and repeating the steps 1 and 2 to obtain forward and reverse flow coefficients, as well as forward and reverse calibration coefficients at the different openings, respectively;
a forward opening V_{A}, the forward flow coefficient K_{A}, and the forward calibration coefficient C_{A} correspond to each other and form a forward fitting array;
a reverse opening V_{B}, the reverse flow coefficient K_{B}, and the reverse calibration coefficient C_{B} correspond to each other and form a reverse fitting array;
step 4. fitting relationships between flow coefficients and needle valve openings according to Formula \textcircled{2}:

$$\{ \begin{matrix}{K}_{A} = f ( {V}_{A} ) \\ {K}_{B} = f ( {V}_{B} )\end{matrix} , \qquad Formula 2$$

step 5. establishing a formula of flow rate, opening and differential pressure according to Formula \textcircled{3}:

$$\{ \begin{matrix}{Q}_{A} = f ( {V}_{A} ) * \sqrt{{DPn}_{A}} + \overline{{C}_{A}} \\ {Q}_{B} = f ( {V}_{B} ) * \sqrt{{DPn}_{B}} + \overline{{C}_{B}}\end{matrix} , \qquad Formula 3$$

in the formula:
C̅_̅{̅A̅}̅ is an average of a plurality of forward calibration coefficients C_{A}; and
C̅_̅{̅B̅}̅ is an average of a plurality of reverse calibration coefficients C_{B}.
step 6. connecting the device body to a production system and injecting a chemical agent;
when a pressure of the chemical agent shows a decline trend from the pressure reduction member to the needle valve assembly, it is determined that the chemical agent flows in the forward direction; and a real-time forward opening of the needle valve assembly is controlled to V_{A}′, a real-time forward first differential pressure DP1_{A}′ and a real-time forward second differential pressure DP2_{A}′ are obtained, and a real-time forward flow rate Q_{A}′ is then calculated according to Formula \textcircled{4}:

$${{Q}_{A}}^{′} = f ( {{V}_{A}}^{′} ) * \sqrt{{{DPn}_{A}}^{′}} + \overline{{C}_{A}} , \qquad Formula 4$$

where DPn_{A}′ is either DP1_{A}′ or DP2_{A}′;
when a pressure of the chemical agent shows an increase trend from the pressure reduction member to the needle valve assembly, it is determined that the chemical agent flows in the reverse direction; and a real-time reverse opening of the needle valve assembly is controlled to V_{B}′, a real-time reverse first differential pressure DP1_{B}′ and a real-time reverse second differential pressure DP2_{B}′ are obtained, and a real-time reverse flow rate Q_{B}′ is then calculated according to Formula \textcircled{5}:

$${{Q}_{B}}^{′} = f ( {{V}_{B}}^{′} ) * \sqrt{{{DPn}_{B}}^{′}} + \overline{{C}_{B}} , \qquad Formula 5$$

Using the above technical solution, the agent input connector and the agent output connector are used as inlets to introduce the agent in an initial stage, forward and reverse flow of the agent inside the device body is simulated, relevant coefficients/parameters are calibrated separately to obtain calculation formulae for the forward and reverse flow rates, and the corresponding calculation formula is then selected according to the forward or reverse flow of the agents to obtain the real-time flow rate, thereby solving the problem of inaccurate measurement caused by the inaccurate unidirectional calibration of parameters. In addition, the above method directly fits the relationship between the flow rate, differential pressure, and opening. In actual application, the real-time flow rate can be obtained based on the real-time opening and differential pressure, thereby solving the problems of slow and inaccurate measurement.

### BRIEF DESCRIPTION OF THE DRAWINGS

FIG. 1 is a structural schematic diagram of a subsea agent injection device according to the present disclosure.

FIG. 2 shows fitting curves of forward Q_{A}-sqrt(DP2_{A}) at different openings according to the present disclosure.

FIG. 3 shows fitting curves of reverse Q_{B}-sqrt(DP2_{B}) at different openings according to the present disclosure.

FIG. 4 shows fitting curves between a forward calibrated flow coefficient K_{A} and an opening V_{A} according to the present disclosure.

FIG. 5 shows fitting curves between a reverse calibrated flow coefficient K_{B} and an opening V_{B} according to the present disclosure.

FIG. 6 is a distribution diagram of a percentage error between a flow rate calculated by DP1_{A}′ and an actual flow rate according to the present disclosure.

FIG. 7 is a distribution diagram of a percentage error between a flow rate calculated by DP2_{A}′ and an actual flow rate according to the present disclosure.

### DETAILED DESCRIPTION OF THE EMBODIMENTS

The present disclosure will be further described below with reference to the embodiments and the accompanying drawings.

### Example 1

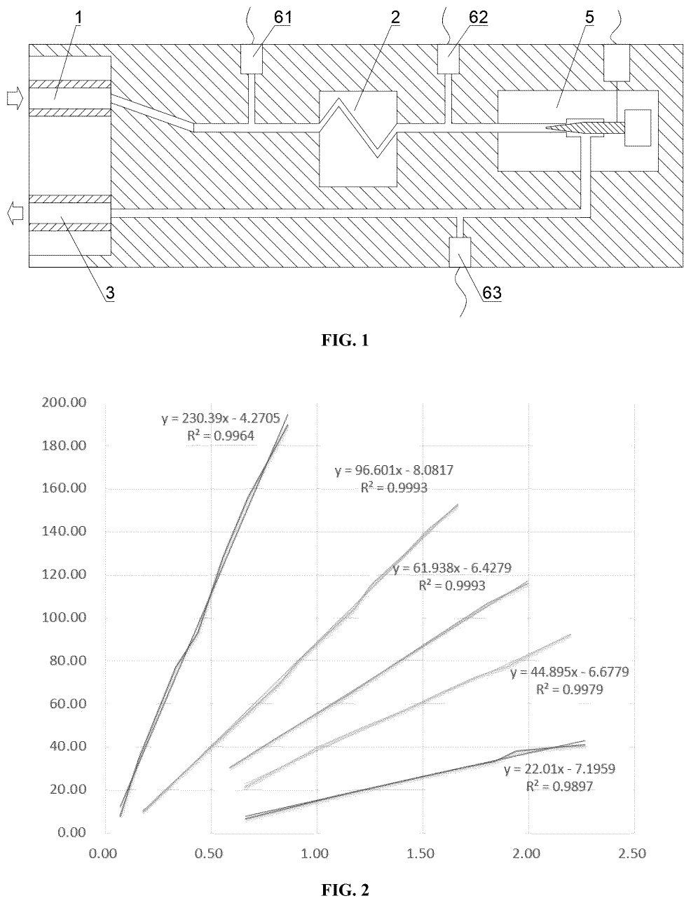

A forward and reverse bidirectional flow rate measurement method for a subsea chemical agent injection device, including a device body, as shown in FIG. 1, where a flow channel is formed inside the device body, the device body includes an agent input connector 1, a pressure reduction member 2, a needle valve assembly 5, and an agent output connector 3 that are sequentially communicated through the flow channel;
the device body further includes a first pressure sensor 61, a second pressure sensor 62 and a third pressure sensor 63;
a pressure detection end of the first pressure sensor 61 is connected to the flow channel at an upstream end of the pressure reduction member 2 to measure a front fluid pressure P1 before the chemical agent flows through the pressure reduction member 2;
a pressure detection end of the second pressure sensor 62 is connected to the flow channel between the pressure reduction member 2 and the needle valve assembly 5 to measure a middle fluid pressure P2 after the chemical agent flows through the pressure reduction member 2 but before the chemical agent flows through the needle valve assembly 5; and
a pressure detection end of the third pressure sensor 63 is connected to the flow channel at a downstream of the needle valve assembly 5 to measure a rear fluid pressure P3 after the chemical agent flows through the needle valve assembly 5.

Output terminals of the first pressure sensor 61, the second pressure sensor 62, and the third pressure sensor 63 are respectively connected to a signal processing transmission module via signal wiring harnesses.

The device body further includes a linear displacement sensor and a rotational displacement sensor, sensing terminals of the linear displacement sensor and the rotational displacement sensor are both connected to an opening and closing function portion of the needle valve assembly 5; and the linear displacement sensor and rotational displacement sensor are mutually redundant, such that an effective and reliable alternative can be provided despite that one position sensing method fails or becomes misaligned; and
both the linear displacement sensor and the rotational displacement sensor are configured to measure a position of the opening and closing function portion of the needle valve assembly 5 (such as, a valve needle/valve stem), thereby obtaining the needle valve opening.

The prior art provides methods for calculating the need valve opening, which will not be elaborated herein.

The method is implemented according to the following steps:
step 1: keeping an opening V of the needle valve assembly 5 fixed, taking the agent input connector 1 and the agent output connector 3 as inlets to inject agents with different calibrated flow rates Q into the device body for forward and reverse bidirectional calibration, and synchronously obtaining first differential pressures DP1 before and after the chemical agent flows through the pressure reduction member 2, and second differential pressures DP2 before and after the chemical agent flows through the needle valve assembly 5 during the period;

$$DP 1 = \vert P 1 - P 2 \vert ;$$

$$DP 2 = \vert P 2 - P 3 \vert ;$$

a forward calibration array and a reverse calibration array for the same opening V are accordingly obtained; where the forward calibration array includes a plurality of forward calibration flow rates, a forward first differential pressure, and a forward second differential pressure; and the reverse calibration array includes a plurality of reverse calibration flow rates, a reverse first differential pressure, and a reverse second differential pressure;
step 2. fitting relationships between flow rates and differential pressures in forward and reverse directions at the same opening V according to Formula \textcircled{1} based on the forward calibration array and the reverse calibration array:

$$\{ \begin{matrix}{Q}_{A} = {K}_{A} * \sqrt{{DPn}_{A}} + {C}_{A} \\ {Q}_{B} = {K}_{B} * \sqrt{{DPn}_{B}} + {C}_{B}\end{matrix} , \qquad Formula 1$$

in the formula:
Q_{A} is a forward flow rate; K_{A} is a forward flow coefficient; C_{A} is a forward calibration coefficient; DPn_{A} is either DP1_{A} or DP2_{A}, DP1_{A} is a forward first differential pressure, and DP2_{A} is a forward second differential pressure; and
Q_{B} is a reverse flow rate; K_{B} is a reverse flow coefficient; C_{B} is a reverse calibration coefficient; DPn_{B} is either DP1_{B} or DP2_{B}, DP1_{B} is a reverse first differential pressure, and DP2_{B} is a reverse second differential pressure;
step 3. adjusting the needle valve assembly 5 to different openings V, and repeating the steps 1 and 2 to obtain forward and reverse flow coefficients, as well as forward and reverse calibration coefficients at the different openings, respectively;
a forward opening V_{A}, the forward flow coefficient K_{A}, and the forward calibration coefficient C_{A} correspond to each other and form a forward fitting array;
a reverse opening V_{B}, the reverse flow coefficient K_{B}, and the reverse calibration coefficient C_{B} correspond to each other and form a reverse fitting array;
the steps 2 and 3 are combined and can also be directly expressed by as the following formula:

$$\{ \begin{matrix}{Q}_{A} = {K}_{A} * \sqrt{{DPn}_{A}} + {C}_{A} = \{ \begin{matrix}{Q}_{A 1} = {K}_{A 1} * \sqrt{{DPn}_{A 1}} + {C}_{A 1} , V = {V}_{A 1} \\ {Q}_{A 2} = {K}_{A 2} * \sqrt{{DPn}_{A 2}} + {C}_{A 2} , V = {V}_{A 2} \\ ⋯ \\ {Q}_{Ai} = {K}_{Ai} * \sqrt{{DPn}_{Ai}} + {C}_{Ai} , V = {V}_{Ai} \\ ⋯ \\ {Q}_{Aj} = {K}_{Aj} * \sqrt{{DPn}_{Aj}} + {C}_{Aj} , V = {V}_{Aj}\end{matrix} \\ {Q}_{B} = {K}_{B} * \sqrt{{DPn}_{B}} + {C}_{B} = \{ \begin{matrix}{Q}_{B 1} = {K}_{B 1} * \sqrt{{DPn}_{B 1}} + {C}_{B 1} , V = {V}_{B 1} \\ {Q}_{B 2} = {K}_{B 2} * \sqrt{{DPn}_{B 2}} + {C}_{B 2} , V = {V}_{B 2} \\ ⋯ \\ {Q}_{Br} = {K}_{Br} * \sqrt{{DPn}_{Br}} + {C}_{Br} , V = {V}_{Br} \\ ⋯ \\ {Q}_{Bk} = {K}_{Bk} * \sqrt{{DPn}_{bK}} + {C}_{Bk} , V = {V}_{Bk}\end{matrix}\end{matrix} ;$$

in the formula:
Q_{Ai} is a flow rate when a forward calibration is performed at an i^{th} opening;
K_{Ai} is a flow coefficient when the forward calibration is performed at the i^{th} opening; DPn_{Ai} is either DP1_{Ai} or DP2_{Ai};
DP1_{Ai} is a first differential pressure when the forward calibration is performed at the i^{th} opening;
DP2_{Ai} is a second differential pressure when the forward calibration is performed at the i^{th} opening;
C_{Ai} is a calibration coefficient when the forward calibration is performed at the i^{th} opening;
V_{Ai} is an i^{th} forward opening;
i=1,2, . . . ,j; and j is a total number of openings during the forward calibration;
Q_{Br} is a flow rate when a reverse calibration is performed at an r^{th} opening;
K_{Br} is a flow coefficient when the reverse calibration is performed at an the r^{th} opening;
DPn_{Br} is either DP1_{Br} or DP2_{Br};
DP1_{Br} is a first differential pressure when the reverse calibration is performed at the r^{th} opening;
DP2_{Br} is a second differential pressure when the reverse calibration is performed at the r^{th} opening;
C_{Br} is a calibration coefficient when the reverse calibration is performed at an the r^{th} opening;
V_{Br} is an r^{th} forward opening; and
r=1,2, . . . ,k; and k is a total number of openings during the reverse calibration;
step 4. fitting relationships between flow coefficients and needle valve openings according to Formula \textcircled{2};
substituting a plurality of K_{Ai} and V_{Ai}, and a plurality of K_{Br} and V_{Br} into Formula \textcircled{2} to fit relationships between the forward flow coefficient and the forward opening, and relationships between the reverse flow coefficient and the reverse opening, respectively.

$$\{ \begin{matrix}{K}_{A} & = f ( {V}_{A} ) \\ {K}_{B} & = f ( {V}_{B} )\end{matrix} , \qquad Formula$$

a specific fitting formula for the flow coefficient and the needle valve opening is as follows:

$$\{ \begin{matrix}{K}_{A} & = f ( {V}_{A} ) = {A}_{A} * {V}_{A} + {D}_{A} \\ {K}_{B} & = f ( {V}_{B} ) = {A}_{B} * {V}_{B} + {D}_{B}\end{matrix} , \qquad Formula$$

where A_{A} and D_{A} are fitting parameters of the forward opening, and A_{B} and D_{B} are fitting parameters of the reverse opening;
step 5. establishing a formula of flow rate, opening and differential pressure according to Formula \textcircled{3}:

$$\{ \begin{matrix}{Q}_{A} & = f ( {V}_{A} ) * \sqrt{{DPn}_{A}} + \overline{{C}_{A}} \\ {Q}_{B} & = f ( {V}_{B} ) * \sqrt{{DPn}_{B}} + \overline{{C}_{B}}\end{matrix} , \qquad Formula$$

in the formula:
C̅_̅{̅A̅}̅ is an average of a plurality of forward calibration coefficients C_{A}; and
C̅_̅{̅B̅}̅ is an average of a plurality of reverse calibration coefficients C_{B}; and
step 6. connecting the device body to a production system and injecting a chemical agent;
when a pressure of the chemical agent shows a decline trend from the pressure reduction member 2 to the needle valve assembly 5, that is, when the front fluid pressure P1 is greater than the rear fluid pressure P3, it is determined that the chemical agent flows in the forward direction; and a real-time forward opening of the needle valve assembly 5 is controlled to V_{A}′, a real-time forward first differential pressure DP1_{A}′ and a real-time forward second differential pressure DP2_{A}′ are obtained, and a real-time forward flow rate Q_{A}′ is then calculated according to Formula \textcircled{4}:

$${Q}_{A}^{′} = f ( {V}_{A}^{′} ) * \sqrt{{DPn}_{A}^{′}} + \overline{{C}_{A}} , \qquad Formula$$

where DPn_{A}′ is either DP1_{A}′ or DP2_{A}′;
when a pressure of the chemical agent shows an increase trend from the pressure reduction member 2 to the needle valve assembly 5, that is, when the rear fluid pressure P3 is greater than the front fluid pressure P1, it is determined that the chemical agent flows in the reverse direction; and a real-time reverse opening of the needle valve assembly 5 is controlled to V_{B}′, a real-time reverse first differential pressure DP1_{B}′ and a real-time reverse second differential pressure DP2_{B}′ are obtained, and a real-time reverse flow rate Q_{B}′ is then calculated according to Formula \textcircled{5}; and

$${Q}_{B}^{′} = f ( {V}_{B}^{′} ) * \sqrt{{DPn}_{B}^{′}} + \overline{{C}_{B}} , \qquad Formula$$

### Example 2

A forward and reverse bidirectional flow rate measurement method for a subsea chemical agent injection device is provided.

This example is substantially the same as Example 1, except that:
in the step 2, a segmented flow rate measurement value Q_{f} is set;
in the step 6, a target flow rate Qₘ is set, and an opening of the needle valve assembly 5 is controlled to make Q_{A}′=Qₘ or Q_{B}′=Qₘ;
when Qₘ>Q_{f}:
in the step 2, DPn_{A} is set to DP1_{A}, and in the step 6, DPn_{A}′ is set to DP1_{A}′;
in the step 2, DPn_{B} is set to DP1_{B}, and in the step 6, DPn_{B}′ is set to DP1_{B}′;
when Qₘ≤Q_{f}:
in the step 2, DPn_{A} is set to DP2_{A}, and in the step 6, DPn_{A}′ is set to DP2_{A}′; and
in the step 2, DPn_{B} is set to DP2_{B}, and in the step 6, DPn_{B}′ is set to DP2_{B}.

That is, DP1_{A}′ and DP1_{A} have a corresponding relationship between the preceding and following equations; when a differential pressure between the forward front fluid pressure P1 and the forward middle fluid pressure P2 is fitted in the step 2, the differential pressure between the forward front fluid pressure P1 and the forward middle fluid pressure P2 should be measured in real time in the step 6;

Similarly, corresponding relationships exist between DP1_{B}′ and DP1_{B}, between DP2_{A} and DP2_{A}, as well as between DP2_{B} and DP2_{B}.

The segmented measurement has the effect of reducing a relative error in flow measurement, and further improving the measurement accuracy.

### Example 3

A forward and reverse bidirectional flow rate measurement method for a subsea chemical agent injection device is provided, the method includes the subsea chemical agent injection device in Example 1, and is implemented by the following steps:
step 1. Bidirectional calibration
step 1.1 Forward calibration:
adjusting the needle valve assembly 5 to a plurality of different forward openings V_{A}, and taking the agent input connector 1 as an inlet to inject agents with different forward flow rates Q_{A} into the device body for calibration;
under each forward opening V_{A} condition, the forward flow rate Q_{A} with sufficient magnitude should be injected, preferably 10 times or more, and the forward flow rate Q_{A} injected each time is different; a forward front fluid pressure P1, a forward middle fluid pressure P2, and a forward rear fluid pressure P3 are synchronously obtained during the process; a forward first differential pressure DP1_{A}=P1−P2, and a forward second differential pressure DP2_{A}=P2−P3;
V_{A}, Q_{A}, DP1_{A} and DP2_{A} correspond to one another and form a forward fitting array; and some of the forward calibration data of V_{A}, Q_{A}, DP1_{A} and DP2_{A} are extracted and shown in Table 1;
step 1.2 Reverse calibration:
adjusting the needle valve assembly 5 to a plurality of different reverse openings V_{B}, and taking the agent output connector 3 as an inlet to inject agents with different reverse flow rates Q_{B} into the device body for calibration;
under each reverse opening V_{B} condition, the reverse flow rate Q_{B} with sufficient magnitude should be injected, preferably 10 times or more, and the reverse flow rate Q_{B} injected each time is different; a reverse front fluid pressure P1, a reverse middle fluid pressure P2, and a reverse rear fluid pressure P3 are synchronously obtained during the process; a reverse first differential pressure DP1_{B}=P2−P1, and a reverse second differential pressure DP2_{B}=P3−P2;
V_{B}, Q_{B}, DP1_{B} and DP2_{B} correspond to one another and form a reverse fitting array; and some of the reverse calibration data of V_{B}, Q_{B}, DP1_{B} and DP2_{B} are extracted and shown in Table 2;
step 2. fitting relationships between the flow rate and the differential pressure at different openings according to the following Formula \textcircled{1};

$$\{ \begin{matrix}{Q}_{A} = {K}_{A} * \sqrt{{DPn}_{A}} + {C}_{A} = \{ \begin{matrix}{Q}_{A 1} = {K}_{A 1} * \sqrt{{DPn}_{A 1}} + {C}_{A 1} , & V = {V}_{A 1} \\ {Q}_{A 2} = {K}_{A 2} * \sqrt{{DPn}_{A 2}} + {C}_{A 2} , & V = {V}_{A 2} \\ & … \\ {Q}_{Ai} = {K}_{Ai} * \sqrt{{DPn}_{Ai}} + {C}_{Ai} , & V = {V}_{Ai} \\ & … \\ {Q}_{Aj} = {K}_{Aj} * \sqrt{{DPn}_{Aj}} + {C}_{Aj} , & V = {V}_{Aj}\end{matrix} \\ {Q}_{B} = {K}_{B} * \sqrt{{DPn}_{B}} + {C}_{B} = \{ \begin{matrix}{Q}_{B 1} = {K}_{B 1} * \sqrt{{DPn}_{B 1}} + {C}_{B 1} , & V = {V}_{B 1} \\ {Q}_{B 2} = {K}_{B 2} * \sqrt{{DPn}_{B 2}} + {C}_{B 2} , & V = {V}_{B 2} \\ & … \\ {Q}_{Br} = {K}_{Br} * \sqrt{{DPn}_{Br}} + {C}_{Br} , & V = {V}_{Br} \\ & … \\ {Q}_{Bk} = {K}_{Bk} * \sqrt{{DPn}_{Bk}} + {C}_{Bk} , & V = {V}_{Bk}\end{matrix}\end{matrix} , \qquad Formula$$

where:
Q_{A} is composed of j Q_{Ai};
Q_{Ai} is a flow rate when a forward calibration is performed at an i^{th} opening;
K_{A} is a forward flow coefficient, which is composed of j K_{Ai};
K_{Ai} is a flow coefficient when the forward calibration is performed at the i^{th} opening;
C_{A} is a forward calibration coefficient, which is composed of j C_{Ai};
C_{Ai} is a calibration coefficient when the forward calibration is performed at the i^{th} opening;
DPn_{A} is composed of j DPn_{Ai};
DPn_{A} is either DP1_{A} or DP2_{A};
DPn_{Ai} is either DP1_{Ai} or DP2_{Ai};
DP1_{A} is composed of j DP1_{Ai};
DP1_{Ai} is a first differential pressure when the forward calibration is performed at the i^{th} opening;
DP2_{A} is composed of j DP2_{Ai};
DP2_{Ai} is a second differential pressure when the forward calibration is performed at the i^{th} opening;
V_{A} is composed of j V_{Ai};
V_{Ai} is an i^{th} forward opening;
i=1,2, . . . ,j; and j is a total number of openings during the forward calibration;
Q_{B} is composed of k Q_{Br};
Q_{Br} is a flow rate when a reverse calibration is performed at an r^{th} opening;
K_{B} is a reverse flow coefficient, which is composed of k K_{Br};
K_{Br} is a flow coefficient when the reverse calibration is performed at an the r^{th} opening;
C_{B} is a reverse calibration coefficient, which is composed of k C_{Br};
C_{Br} is a calibration coefficient when the reverse calibration is performed at an the r^{th} opening;
DPn_{B} is composed of k DPn_{Br};
DPn_{B} is either DP1_{B} or DP2_{B};
DPn_{Br} is either DP1_{Br} or DP2_{Br};
DP1_{B} is composed of k DP1_{Br};
DP1_{Br} is a first differential pressure when the reverse calibration is performed at the r^{th} opening;
DP2_{B} is composed of k DP2_{Br};
DP2_{Br} is a second differential pressure when the reverse calibration is performed at the r^{th} opening;
V_{B} is composed of k V_{Br};
V_{Br} is the r^{th} reverse opening;
r=1,2, . . . ,k; and k is a total number of openings during the reverse calibration;

After the above fitting, a calibration array of the same opening is fitted to obtain a flow coefficient and a calibration coefficient, that is:
a plurality of forward openings V_{A}, forward flow coefficients K_{A}, and forward calibration coefficients C_{A} correspond to one another and form a forward fitting array;
a plurality of reverse openings V_{B}, reverse flow coefficients K_{B}, and reverse calibration coefficients C_{B} correspond to one another and form a reverse fitting array;

Assuming that DPn_{A} is DP2_{A} and DPn_{B} is DP2_{B}, and taking it as an example: the forward flow coefficient K_{A} and the forward calibration coefficient C_{A} obtained from fitting are shown in Table 1; and the reverse flow coefficient K_{B} and the reverse calibration coefficient C_{B} obtained from fitting are shown in Table 2;

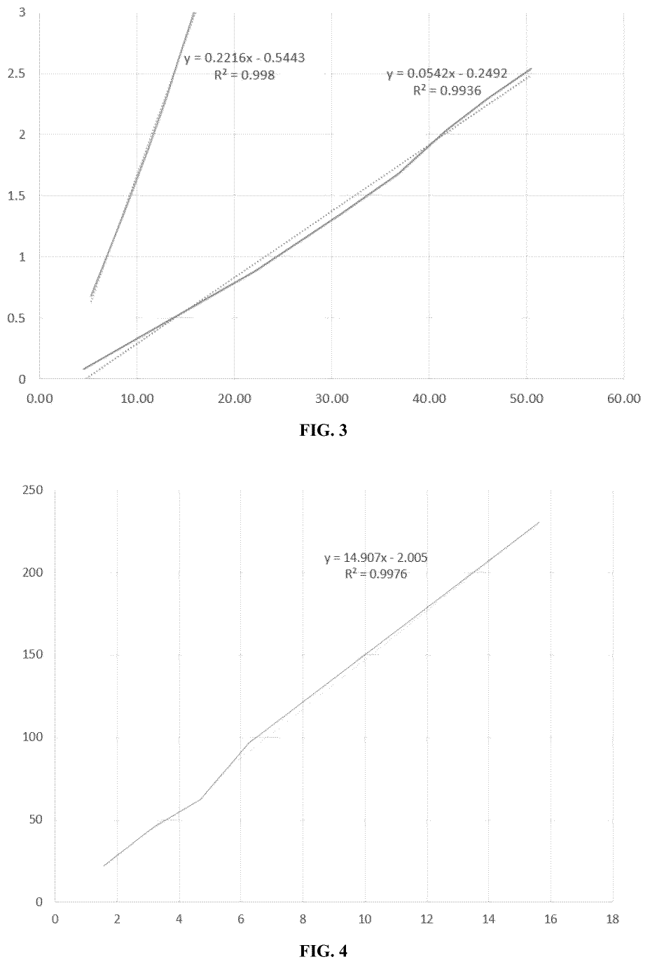

In order to more intuitively observe a linear relationship between the flow rate and differential pressure, flow rate curves QA-sqrt(DP2_{A}) and QB-sqrt(DP2_{B}) for forward and reverse bidirectional flows at different openings V are plotted, and results are shown in FIGS. 2 and 3, respectively. It can be seen from FIGS. 2 and 3 that the flow rate has a good linear relationship with sqrt(DP2) no matter whether the agents flow in the forward direction or in the reverse direction.
step 3. fitting relationships between flow coefficients and needle valve openings according to Formula \textcircled{2} based on the forward fitting array and the reverse fitting array;

$$\{ \begin{matrix}{K}_{A} & = f ( {V}_{A} ) = {A}_{A} * {V}_{A} + {D}_{A} \\ {K}_{B} & = f ( {V}_{B} ) = {A}_{B} * {V}_{B} + {D}_{B}\end{matrix} , \qquad Formula$$

a plurality of K_{Ai} and V_{Ai}, and a plurality of K_{Br} and V_{Br} are substituted into Formula \textcircled{2} for separate fitting to obtain forward opening fitting parameters A_{A} and D_{A}, as well as reverse opening fitting parameters A_{B} and D_{B}. Fitting results of A_{A}, D_{A}, A_{B} and D_{B} are shown in Tables 1 and 2:

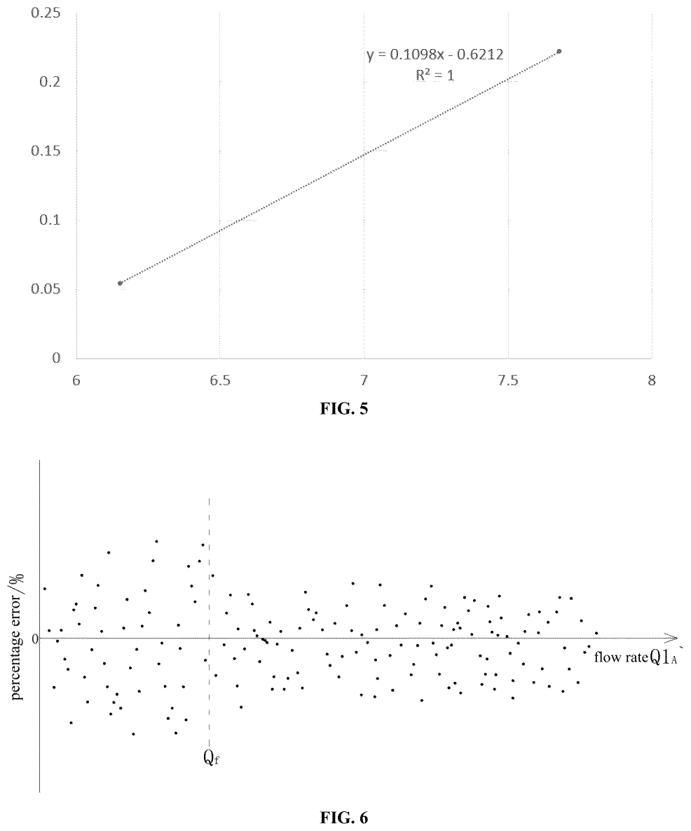

In order to more intuitively observe a linear relationship between the flow coefficient and the opening, K-V curves between the flow coefficient and the opening V in the forward and reverse directions are plotted, and results are shown in FIGS. 4 and 5. It can be seen from FIGS. 4 and 5 that the flow coefficient has a good relationship with the opening when the agent flows in the forward and reverse directions;
therefore, the relationship between the flow rate, the opening, and the differential pressure is obtained, as shown in Formula \textcircled{3}:

$$\{ \begin{matrix}{Q}_{A} = f ( {V}_{A} ) * \sqrt{{DPn}_{A}} + \overline{{C}_{A}} & = ( 14.907 * {V}_{A} - 2.005 ) * \sqrt{DP {2}_{A}} + \overline{{C}_{A}} \\ {Q}_{B} = f ( {V}_{B} ) * \sqrt{{DPn}_{B}} + \overline{{C}_{B}} & = ( 0. 1098 * {V}_{B} - 0.6212 ) * \sqrt{DP {2}_{B}} + \overline{{C}_{B}}\end{matrix} , \qquad Formula$$

C̅_̅{̅A̅}̅ is an average of a plurality of forward calibration coefficients C_{A}; and
C̅_̅{̅B̅}̅ is an average of a plurality of reverse calibration coefficients C_{B}.

TABLE 1
Statistics of forward calibration array, fitting array, and some opening fitting parameters

| | | Q_{A} | | | | | | | | | |
|---|---|---|---|---|---|---|---|---|---|---|---|
| S/N | V_{A}/% | L/h | P1/Mpa | P2/Mpa | P3/MPa | DP1_{A}/MPa | DP2_{A}/MPa | K_{A} | C_{A} | A_{A} | D_{A} |
| 1-1 | 6.25 | 152.4 | 6.296 | 2.901 | 0.122 | 3.395 | 2.779 | 44.895 | −6.678 | 14.907 | −2.005 |
| 1-2 | | 141.6 | 5.437 | 2.471 | 0.119 | 2.966 | 2.352 | | | | |
| 1-3 | | 129.6 | 4.652 | 2.128 | 0.117 | 2.524 | 2.011 | | | | |
| 1-4 | | 115.2 | 3.63 | 1.693 | 0.114 | 1.937 | 1.579 | | | | |
| 1-5 | | 104.4 | 3.202 | 1.51 | 0.113 | 1.692 | 1.397 | | | | |
| . . . | | . . . | . . . | . . . | . . . | . . . | . . . | | | | |
| 2-1 | 3.125 | 92.4 | 6.296 | 0.115 | 4.954 | 1.342 | 4.839 | 96.601 | −8.082 | | |
| 2-2 | | 87.6 | 5.769 | 0.114 | 4.534 | 1.235 | 4.42 | | | | |
| 2-3 | | 82.8 | 5.209 | 0.113 | 4.127 | 1.082 | 4.014 | | | | |
| 2-4 | | 77.4 | 4.657 | 0.112 | 3.731 | 0.926 | 3.619 | | | | |
| 2-5 | | 72.6 | 3.967 | 0.112 | 3.215 | 0.752 | 3.103 | | | | |
| . . . | | . . . | . . . | . . . | . . . | . . . | . . . | | | | |
| 3-1 | 4.6875 | 30 | 0.583 | 0.454 | 0.106 | 0.129 | 0.348 | 61.938 | −6.428 | | |
| 3-2 | | 45.6 | 1.092 | 0.811 | 0.107 | 0.281 | 0.704 | | | | |
| 3-3 | | 64.2 | 2.035 | 1.435 | 0.109 | 0.6 | 1.326 | | | | |
| 3-4 | | 79.8 | 2.979 | 2.035 | 0.109 | 0.944 | 1.926 | | | | |
| 3-5 | | 92.4 | 3.917 | 2.62 | 0.111 | 1.297 | 2.509 | | | | |
| . . . | | . . . | . . . | . . . | . . . | . . . | . . . | | | | |
| 4-1 | 15.625 | 189.6 | 6.089 | 0.871 | 0.127 | 5.218 | 0.744 | 22.01 | −7.196 | | |
| 4-2 | | 172.2 | 5.143 | 0.715 | 0.123 | 4.428 | 0.592 | | | | |
| 4-3 | | 156 | 4.165 | 0.577 | 0.121 | 3.588 | 0.456 | | | | |
| 4-4 | | 128.4 | 3.069 | 0.431 | 0.117 | 2.638 | 0.314 | | | | |
| 4-5 | | 93 | 1.953 | 0.306 | 0.114 | 1.647 | 0.192 | | | | |
| . . . | | . . . | . . . | . . . | . . . | . . . | . . . | | | | |
| 5-1 | 1.5625 | 40.8 | 5.477 | 5.249 | 0.106 | 0.228 | 5.143 | 230.39 | −4.271 | | |
| 5-2 | | 37.8 | 4.122 | 3.876 | 0.106 | 0.246 | 3.77 | | | | |
| 5-3 | | 33 | 3.666 | 3.491 | 0.106 | 0.175 | 3.385 | | | | |
| 5-4 | | 30 | 3.083 | 2.959 | 0.106 | 0.124 | 2.853 | | | | |
| 5-5 | | 25.8 | 2.386 | 2.295 | 0.106 | 0.091 | 2.189 | | | | |
| . . . | | . . . | . . . | . . . | . . . | . . . | . . . | | | | |

TABLE 2
Statistics of reverse calibration array, fitting array, and some opening fitting parameters

| | | Q_{B} | | | | | | | | | |
|---|---|---|---|---|---|---|---|---|---|---|---|
| S/N | V_{B}/% | L/h | P1/Mpa | P2/Mpa | P3/MPa | DP1_{B}/MPa | DP2_{B}/MPa | K_{B} | C_{B} | A_{B} | D_{B} |
| 1-1 | 6.1532 | 0.88 | 10.63 | 51.58 | 100.51 | 40.95 | 48.93 | 0.0542 | −0.2492 | 0.1098 | −0.6212 |
| 1-2 | | 1.68 | 11.19 | 170.23 | 305.82 | 159.04 | 135.59 | | | | |
| 1-3 | | 2.04 | 11.44 | 230.58 | 405.38 | 219.14 | 174.79 | | | | |
| 1-4 | | 2.3 | 11.67 | 291.20 | 503.46 | 279.53 | 212.26 | | | | |
| 1-5 | | 2.54 | 11.95 | 356.45 | 611.70 | 344.5 | 255.25 | | | | |
| . . . | | . . . | . . . | . . . | . . . | . . . | . . . | | | | |
| 2-1 | 7.6783 | 12.93 | 582.80 | 611.40 | 569.87 | 28.60 | 12.93 | 0.2216 | −0.5443 | | |
| 2-2 | | 12.52 | 486.47 | 511.49 | 473.95 | 25.02 | 12.52 | | | | |
| 2-3 | | 12.09 | 385.31 | 406.24 | 373.22 | 20.92 | 12.09 | | | | |
| 2-4 | | 11.71 | 296.89 | 314.17 | 285.18 | 17.28 | 11.71 | | | | |
| 2-5 | | 10.57 | 34.28 | 37.09 | 23.71 | 2.81 | 10.57 | | | | |
| . . . | | . . . | . . . | . . . | . . . | . . . | . . . | | | | |

Step 5. For a more intuitive comparison, making the forward first differential pressure DP1_{A} and the second differential pressure DP2_{A} in Table 1 equivalent as the forward real-time first differential pressure DP1_{A}′ and the second differential pressure DP2_{A}′, respectively, substituting them into the corresponding formulae respectively to obtain real-time flow rates Q1_{A}′ and Q2_{A}′; and Q1_{A}′ is the real-time forward flow rate calculated using DP1_{A}′, and Q2_{A}′ is the real-time forward flow rate calculated using DP2_{A}′; and taking the calibration flow rate Q as the actual flow rate to calculate a percentage error between the real-time flow rate and an actual flow rate.

The results indicate that:

The percentage error between the real-time flow rate Q1_{A}′ and the actual flow rate is (−6.67%)−(+5.19%);

the percentage error between the real-time flow rate Q2_{A}′ and the actual flow rate is (−7.49%)−(+5.84%); and

Overall, the use of DP1_{A}, DP2_{A}, DP1_{A}′ and DP2_{A}′ to fit and calculate the real-time flow rates results in relatively small error ranges, and can get accurate results.

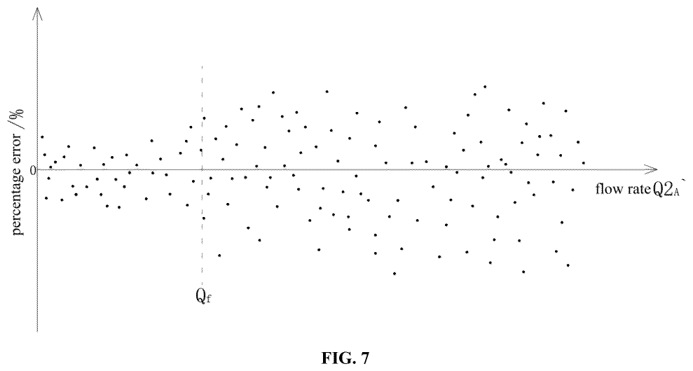

The relationship between percentage errors and actual flow rates corresponding to Q1_{A} and Q2_{A}′ are respectively plotted in coordinate systems, and results are shown in FIGS. 6 and 7. It can be seen from FIGS. 6 and 7 that:
when the flow rate is large, the percentage errors obtained through fitting and calculation of DP1_{A}/DP1_{A}′ by using are more concentrated, and the error ranges thereof are relatively small; while the percentage errors obtained through fitting and calculation of DP2_{A}/DP2_{A}′ by using are relatively dispersed, and the error ranges thereof are relatively larger; and
when the flow rate is small, the percentage errors obtained through fitting and calculation of DP2_{A}/DP2_{A}′ by using are more concentrated, and the error ranges thereof are relatively small; while the percentage errors obtained through fitting and calculation of DP1_{A}/DP1_{A}′ by using are relatively dispersed, and the error ranges thereof are relatively larger.

Therefore, different fitting and/or calculation methods can be adopted to measure the segmented real-time flow rate according to a magnitude of target flow rate: a key to segmentation is to identify a boundary point between a high flow rate and a lower flow rate; the boundary point is generally set manually according to the calibration results, and the boundary point is the segmented flow rate measurement value Q_{f}.

Therefore, when measuring and controlling the real-time flow, the corresponding differential pressure and flow rate formula can be selected based on the target flow rate Qₘ and the segmented flow rate measurement value Q_{f} to calculate the real-time flow rate, so as to obtain more accurate results, that is, the segmented control as specified in Example 2 can be performed.

Beneficial effects: The technical solution of the present disclosure can detect an installation direction of the subsea agent injection device and accurately measure the flow rates of the forward and reverse bidirectional installation conditions, thereby avoid inaccurate flow measurement results due to inverted installation direction. In addition, the present disclosure simplifies the real-time flow rate measurement process by obtaining only differential pressure and needle valve opening.

Finally, it should be noted that the above description is only the preferred embodiment of the present disclosure. Under the inspiration of the present disclosure, a person of ordinary skill in the art can make various similar representations without departing from the spirit of the present disclosure and the claims, and such changes all fall within the protection scope of the present disclosure.

What is claimed is:

1. A forward and reverse bidirectional flow rate measurement method for a subsea chemical agent injection device, comprising a device body, wherein the device body comprises an agent input connector, a pressure reduction member, a needle valve assembly, and an agent output connector that are sequentially communicated through a flow channel;
step 1: keeping an opening V of the needle valve assembly fixed, taking the agent input connector and the agent output connector as inlets to inject agents with different calibrated flow rates Q into the device body for forward and reverse bidirectional calibration, and synchronously obtaining first differential pressures DP1 before and after a chemical agent flows through the pressure reduction member, and second differential pressures DP2 before and after the chemical agent flows through the needle valve assembly during a period; and
obtaining a forward calibration array and a reverse calibration array for the opening V;
step 2: fitting relationships between flow rates and differential pressures in forward and reverse directions at the same opening V according to Formula \textcircled{1}:
$$\{ \begin{matrix}{Q}_{A} & = {K}_{A} * \sqrt{{DPn}_{A}} + {C}_{A} \\ {Q}_{B} & = {K}_{B} * \sqrt{{DPn}_{B}} + {C}_{B}\end{matrix} , \qquad Formula$$
in the formula:
Q_{A} is a forward flow rate; K_{A} is a forward flow coefficient; C_{A} is a forward calibration coefficient; DPn_{A} is either DP1_{A} or DP2_{A}, DP1_{A} is a forward first differential pressure, and DP2_{A} is a forward second differential pressure; and
Q_{B} is a reverse flow rate; K_{B} is a reverse flow coefficient; C_{B} is a reverse calibration coefficient; DPn_{B} is either DP1_{B} or DP2_{B}, DP1_{B} is a reverse first differential pressure, and DP2_{B} is a reverse second differential pressure;
step 3: adjusting the needle valve assembly to different openings V, and repeating the steps 1 and 2 to obtain forward and reverse flow coefficients, as well as forward and reverse calibration coefficients at the different openings V, respectively;
a forward opening V_{A}, the forward flow coefficient K_{A}, and the forward calibration coefficient C_{A} correspond to each other and form a forward fitting array; and
a reverse opening V_{B}, the reverse flow coefficient K_{B}, and the reverse calibration coefficient C_{B} correspond to each other and form a reverse fitting array;
step 4: fitting relationships between flow coefficients and needle valve openings according to Formula \textcircled{2}:
$$\{ \begin{matrix}{K}_{A} & = f ( {V}_{A} ) \\ {K}_{B} & = f ( {V}_{B} )\end{matrix} , \qquad Formula$$
step 5: establishing a formula of flow rate, opening, and differential pressure according to Formula \textcircled{3}:
$$\{ \begin{matrix}{Q}_{A} & = f ( {V}_{A} ) * \sqrt{{DPn}_{A}} + \overline{{C}_{A}} \\ {Q}_{B} & = f ( {V}_{B} ) * \sqrt{{DPn}_{B}} + \overline{{C}_{B}}\end{matrix} , \qquad Formula$$
in the formula:
C̅_̅{̅A̅}̅ is an average of a plurality of forward calibration coefficients C_{A}; and
C̅_̅{̅B̅}̅ is an average of a plurality of reverse calibration coefficients C_{B};
step 6: connecting the device body to a production system and injecting the chemical agent;
when a pressure of the chemical agent shows a decline trend from the pressure reduction member to the needle valve assembly, the chemical agent is determined to flow in a forward direction; and a real-time forward opening of the needle valve assembly is controlled to V_{A}′, a real-time forward first differential pressure DP1_{A}′ and a real-time forward second differential pressure DP2_{A}′ are obtained, and a real-time forward flow rate Q_{A}′ is then calculated according to Formula \textcircled{4}:
$${Q}_{A}^{′} = f ( {V}_{A}^{′} ) * \sqrt{{DPn}_{A}^{′}} + \overline{{C}_{A}} , \qquad Formula$$
in the formula, DPn_{A}′ is either DP1_{A}′ or DP2_{A}′; and
when the pressure of the chemical agent shows an increase trend from the pressure reduction member to the needle valve assembly, the chemical agent is determined to flow in a reverse direction; and a real-time reverse opening of the needle valve assembly is controlled to V_{B}′, a real-time reverse first differential pressure DP1_{B}′ and a real-time reverse second differential pressure DP2_{B}′ are obtained, and a real-time reverse flow rate Q_{B}′ is then calculated according to Formula \textcircled{5}:
$${Q}_{B}^{′} = f ( {V}_{B}^{′} ) * \sqrt{{DPn}_{B}^{′}} + \overline{{C}_{B}} , \qquad Formula$$

2. The forward and reverse bidirectional flow rate measurement method for the subsea chemical agent injection device according to claim 1, wherein in the step 4:
$$\{ \begin{matrix}{K}_{A} & = f ( {V}_{A} ) = {A}_{A} * {V}_{A} + {D}_{A} \\ {K}_{B} & = f ( {V}_{B} ) = {A}_{B} * {V}_{B} + {D}_{B}\end{matrix} , \qquad Formula$$
in the formula, A_{A} and D_{A} are fitting parameters of the forward opening V_{A}, and A_{B} and D_{B} are fitting parameters of the reverse opening V_{B}.

3. The forward and reverse bidirectional flow rate measurement method for the subsea chemical agent injection device according to claim 1, wherein
in the step 2, a segmented flow rate measurement value Q_{f} is set;
in the step 6, a target flow rate Qₘ is set, and the opening V of the needle valve assembly is controlled to make Q_{A}′=Qₘ or Q_{B}=Qₘ;
when Qₘ>Q_{f}:
in the step 2, DPn_{A} is set to DP1_{A}, and in the step 6, DPn_{A}′ is set to DP1_{A}′;
in the step 2, DPn_{B} is set to DP1_{B}, and in the step 6, DPn_{B}′ is set to DP1_{B};
when Qₘ≤Q_{f}:
in the step 2, DPn_{A} is set to DP2_{A}, and in the step 6, DPn_{A}′ is set to DP2_{A}′; and
in the step 2, DPn_{B} is set to DP2_{B}, and in the step 6, DPn_{B}′ is set to DP2_{B}′.

4. The forward and reverse bidirectional flow rate measurement method for the subsea chemical agent injection device according to claim 1, wherein the device body further comprises a first pressure sensor, a second pressure sensor, and a third pressure sensor;
the first pressure sensor is connected to the flow channel at an upstream end of the pressure reduction member to measure a front fluid pressure P1 before the chemical agent flows through the pressure reduction member;
the second pressure sensor is connected to the flow channel between the pressure reduction member and the needle valve assembly to measure a middle fluid pressure P2 after the chemical agent flows through the pressure reduction member but before the chemical agent flows through the needle valve assembly; and
the third pressure sensor is connected to the flow channel at a downstream of the needle valve assembly to measure a rear fluid pressure P3 after the chemical agent flows through the needle valve assembly.

5. The forward and reverse bidirectional flow rate measurement method for the subsea chemical agent injection device according to claim 4, wherein in the step 6, when the front fluid pressure P1 is greater than the rear fluid pressure P3, the chemical agent is determined to flow in the forward direction; and when the rear fluid pressure P3 is greater than the front fluid pressure P1, the chemical agent is determined to flow in the reverse direction.

6. The forward and reverse bidirectional flow rate measurement method for the subsea chemical agent injection device according to claim 1, wherein the device body further comprises a linear displacement sensor and a rotational displacement sensor; and
sensing terminals of the linear displacement sensor and the rotational displacement sensor are both connected to an opening and closing function portion of the needle valve assembly.

7. The forward and reverse bidirectional flow rate measurement method for the subsea chemical agent injection device according to claim 2, wherein
in the step 2, a segmented flow rate measurement value Q_{f} is set;
in the step 6, a target flow rate Qₘ is set, and the opening V of the needle valve assembly is controlled to make Q_{A}′=Qₘ or Q_{B}′=Qₘ;
when Qₘ>Q_{f}:
in the step 2, DPn_{A} is set to DP1_{A}, and in the step 6, DPn_{A}′ is set to DP1_{A}′;
in the step 2, DPn_{B} is set to DP1_{B}, and in the step 6, DPn_{B}′ is set to DP1_{B}′;
when Qₘ≤Q_{f}:
in the step 2, DPn_{A} is set to DP2_{A}, and in the step 6, DPn_{A}′ is set to DP2_{A}′; and
in the step 2, DPn_{B} is set to DP2_{B}, and in the step 6, DPn_{B}′ is set to DP2_{B}.

8. The forward and reverse bidirectional flow rate measurement method for the subsea chemical agent injection device according to claim 2, the device body further comprises a first pressure sensor, a second pressure sensor, and a third pressure sensor;
the first pressure sensor is connected to the flow channel at an upstream end of the pressure reduction member to measure a front fluid pressure P1 before the chemical agent flows through the pressure reduction member;
the second pressure sensor is connected to the flow channel between the pressure reduction member and the needle valve assembly to measure a middle fluid pressure P2 after the chemical agent flows through the pressure reduction member but before the chemical agent flows through the needle valve assembly; and
the third pressure sensor is connected to the flow channel at a downstream of the needle valve assembly to measure a rear fluid pressure P3 after the chemical agent flows through the needle valve assembly.

9. The forward and reverse bidirectional flow rate measurement method for the subsea chemical agent injection device according to claim 8, wherein in the step 6, when the front fluid pressure P1 is greater than the rear fluid pressure P3, the chemical agent is determined to flow in the forward direction; and when the rear fluid pressure P3 is greater than the front fluid pressure P1, the chemical agent is determined to flow in the reverse direction.
